(19) United States
(12) Patent Application Publication
(10) Pub. No.: US 2007/0021953 A1
(43) Pub. Date: Jan. 25, 2007

(54) Device simulation apparatus, device simulation method, and device simulation program

(76) Inventors: Shuichi Toriyama, Yokohama-Shi (JP); Kazuya Matsuzawa, Kawasaki-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/486,034

(22) Filed: Jul. 14, 2006

(30) Foreign Application Priority Data
Jul. 15, 2005 (JP) 2005-207060

(51) Int. Cl. G06G 7/48; G06G 7/58

(52) U.S. Cl. 703/11; 703/12

(57) ABSTRACT

A device simulation apparatus has a mesh dividing unit, an impurity concentration setting unit, a reference plane setting unit, an impurity profile determination unit, an impurity surface density determination unit configured to determine the impurity surface density on a surface in a predetermined direction, the surface passing through the position of each impurity atom, a folding unit which folds the impurity surface density corresponding to each impurity atom determined by the impurity surface density determination unit, on the reference plane, and an electric property estimating unit configured to estimate electric properties of the semiconductor device structure by using the impurity surface density on the reference plane folded by the folding unit.

### CROSS REFERENCE TO RELATED APPLICATIONS

This application is based upon and claims the benefit of priority from the prior Japanese Patent Application No. 2005-207060, filed on Jul. 15, 2005, the entire contents of which are incorporated herein by reference.

### BACKGROUND OF THE INVENTION

1. Field of the Invention

The present invention relates to a device simulation apparatus, a device simulation method, and a device simulation program that analyze electric properties of a semiconductor device using a simulation.

2. Related Art

High integration of LSIs results in a miniaturization of semiconductor devices at the same time, and the gate length of a smaller LSI of commercially available LSIs is already less than 1000 μm. The high integration of LSIs is a factor of rapid increase of development cost. In order to reduce the cost, it is required to shorten development period and make effective development.

As for such a miniature semiconductor device, there is a problem that the properties of the device fluctuate due to impurity fluctuation. Therefore, it is worried that integration of LSIs may not increase in terms of yield and the other reason. This problem is pointed out by experiments (see: T. Mizuno et. al., “Experimental Study of Threshold Voltage Fluctuation Due to Statistical Variation of Channel Dopant Number in MOSFET's”, IEEE Trans. Electron Devices 41, 2216 (1994)), or computer simulations (see: A. Asenov, “Random Dopant induced Threshold Voltage Lowering and Fluctuations in Sub-0.1 um MOSFET's; A 3-D ‘Atomisitc’ Simulation Study”, IEEE Trans. Electron Devices 45, 2505(1998)).

Here, the impurity fluctuation means that the number or positions of impurities introduced into the semiconductor device fluctuates depending on location. This is due to the fact that, when impurity ions are introduced into the semiconductor device, a process including a random step such as diffusion or ion implantation is used under the present situation, thereby, it is difficult to precisely control the number or positions of impurity atoms, resulting in inevitable variation of the impurity distribution in the semiconductor device.

In a stationary simulation for calculating the electric properties of the semiconductor device, it is known that the following basic equations become governing equations of the device properties (see: Japanese Patent Laid Open Publication No. 2002-184969).
∇·ε∇Φ=−q(p−n+Nd−Na) (1)
∇·nvₑ=GR (2)
∇·pvₕ=GR (3)

Equation (1) is Poisson equation for calculating static electric field in the semiconductor device, equation (2) is a current continuity equation of electron, and equation (3) is a current continuity equation of hole. In these equations, ε is dielectric constant due to the semiconductor device, φ is electric field, q is elementary electric charge, ρ is concentration of holes, n is concentration of electrons, Nd is donor concentration, Na is acceptor concentration, vₑ is electron velocity (vector), vₕ is hole velocity (vector), and GR is a generation and annihilation term.

The electron velocity vₑ and the hole velocity vₕ are given by the following auxiliary equation.

$$\begin{matrix}{nv}_{e} = {μ}_{e} ( - n ∇ ϕ + \frac{{k}_{B}}{q} ∇ ( {nT}_{e} ) ) & ( 4 ) \\ {pv}_{h} = {μ}_{h} ( p ∇ ϕ + \frac{{k}_{B}}{q} ∇ ( {pT}_{h} ) ) & ( 5 )\end{matrix}$$

Here, equation (4) is the equation of electron current density, equation (5) is the equation of hole current density. Where μₑ is electron mobility, μₕ is mobility, k_{B} is Boltzmann constant, Tₑ is electron temperature, and Tₕ is hole temperature.

By self-consistently solving the above equations (1) to (5), stable state values of physical quantities of the semiconductor device, such as electric potential φ, electron concentration n, or hole concentration p can be obtained.

The problem that the electric properties of the semiconductor device fluctuates due to the impurity fluctuation denotes that the impurity concentration term at the right-hand side of the Poisson equation (1) shifts from a common designed value for each device due to the impurity fluctuation. Due to this problem, even if the same bias condition is given, physical quantities of the semiconductor device such as electric field φ electron concentration n, hole concentration p, which are calculated from the above governing equations, differs from each device, resulting in variation of the electric properties between devices and instability of operation as the integrated circuit.

In order to deal with this problem, in the miniature semiconductor device, a statistical analyzing method in which the variation of electric properties in the semiconductor device due to the above-mentioned impurity fluctuation is predicted in advance by the device simulation before fabricating a prototype has been tried in a micro semiconductor device.

As for a conventional simulation of the impurity fluctuation using a classical drift diffusion method, a method for calculating the impurity concentration term at the right-hand side of Poisson equation (1) by a three dimensional device simulator, using a model of Sano et. al, is known at home and abroad (see: N. Sano et al, “On discrete random dopant modeling in drift-diffusion simulations: physical meaning of ‘atomistic’ dopants”, Microelectronics Reliability 42,189(2002)).

In this method, a large number of simulation samples reproducing how the variations of the number or position coordinates of the impurities differ between every devices are prepared by changing random number species. the electric properties of these samples are calculated by the device simulation. The calculated results are statistically analyzed to extract statistical quantities such as mean value, standard deviation, or degree of distortion. These statistical quantities are used for designing LSI or predicting yield of LSI.

As described above, the variation of the number or positions of impurities is essentially variation in a three dimensional space. In a usual impurity fluctuation simulation, a device simulator that can calculate three dimensional electrostatic potential, is required.

However, in the three dimensional simulation, the calculated quantity becomes voluminously. For example, as for the standard deviation, it is assumed that the standard deviation of population (population variance) of the variation of the device properties is estimated from the statistics of the simulation results. In this situation, assuming that the population variance follows normal distribution and using the concept of chi-square test, it is required to calculate at least 200 order of simulation samples to obtain the simulation results within ±10% error at 95% degree of reliability.

In an n-type MOSFET with structure having 20 nm of gate length L and gate width W, and 2 nm of gate insulating film, the present inventor took the impurity fluctuation into consideration by the three dimensional simulation using the model of the above-mentioned non-patent reference 3, and calculated the current-voltage characteristics (Id-Vg characteristics) for 200 simulation samples that meet the above requirement of the degree of reliability. As a result, it took about 120 hours on a workstation of sun4u Ultra-SPARCIII 1280 MHz(Memory size 8 GB) to complete the calculations for the 200 samples.

In this manner, if the variation of the electric properties of the semiconductor device due to impurity fluctuation is analyzed, which have to consider three dimensional positions of impurities essentially, it is considered necessary to use the three dimensional device simulator. However, there is a problem that a great investment of time is required for the statistical analysis.

### SUMMARY OF THE INVENTION

According to one embodiment of the present invention, a device simulation apparatus, comprising:

a mesh dividing unit configured to divide a semiconductor device structure for a simulation into three dimensional mesh shape;

an impurity concentration setting unit configured to set the number or positions of impurity atoms for each control volume corresponding to a basic unit divided into mesh shape;

a reference plane setting unit configured to set a reference plane as a standard for calculating a impurity surface density in the semiconductor device structure divided in mesh shape;

an impurity profile determination unit configured to determine a impurity profile of the semiconductor device structure based on the number or positions of the impurity atoms set by the impurity concentration setting unit;

an impurity surface density determination unit configured to determine the impurity surface density on a surface in a predetermined direction, the surface passing through the position of each impurity atom;

a folding unit which folds the impurity surface density corresponding to each impurity atom determined by the impurity surface density determination unit, on the reference plane; and

an electric property estimating unit configured to estimate electric properties of the semiconductor device structure by using the impurity surface density on the reference plane folded by the folding unit.

According to one embodiment of the present invention, a device simulation method, comprising:

dividing a semiconductor device structure for simulation into three dimensional mesh shape;

setting the number or positions of impurity atoms for each control volume corresponding to a basic unit divided into mesh shape;

setting a reference plane as a standard for calculating a impurity surface density in the semiconductor device structure divided into mesh shape;

determining a impurity profile of the semiconductor device structure based on the set number or positions of the impurity atoms;

determining the impurity surface density on a surface in a predetermined direction based on the impurity profile, the surface passing through the position of each impurity atom;

folding the impurity surface density corresponding to each of the determined impurity atoms, on the reference plane; and

estimating electric properties of the semiconductor device structure by using the impurity surface density on the folded reference plane.

### BRIEF DESCRIPTION OF THE DRAWINGS

FIG. 1 is a block diagram illustrating schematic configuration of a device simulation apparatus according to one embodiment of the present invention.

FIG. 2 is a flow chart illustrating the processing operations of the device simulation apparatus of FIG. 1.

FIG. 3 is a view illustrating an example in which impurity concentration is allocated to each control volume.

FIG. 4 is a view illustrating one example of the reference plane 10.

FIG. 5 is a flowchart showing a detailed processing procedure in step S5 of FIG. 2.

FIG. 6 is a schematic view of the processing in step S14.

FIG. 7 is a schematic view of the processing in step S15.

FIG. 8 is a view of current-voltage characteristics resulting from the calculation performed by concerning impurity fluctuation for two hundreds of n-type MOSFETs.

FIG. 9 is a view illustrating the results of significance tests between the result of the three dimensional device simulation using a known model and the result of the simulation by the manner of the present embodiment.

### DETAILED DESCRIPTION OF THE INVENTION

Now, referring to drawings, one embodiment of the present invention will be described below.

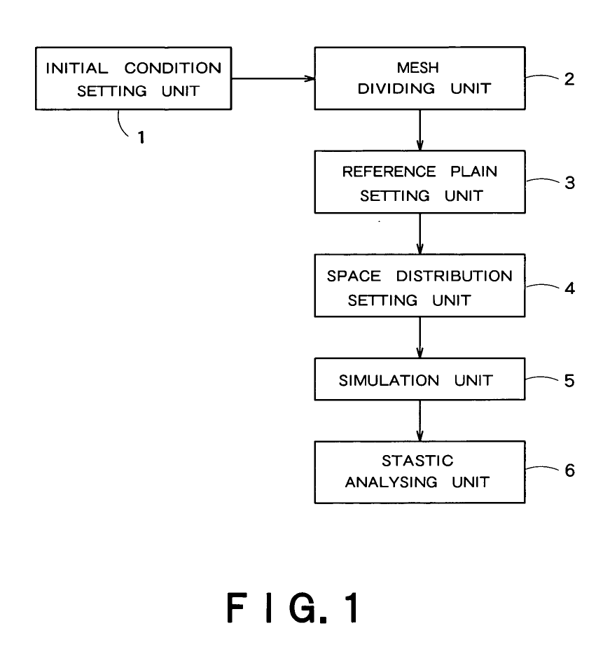

FIG. 1 is a block diagram illustrating schematic configuration of a device simulation apparatus according to one embodiment of the present invention. The device simulation apparatus of FIG. 1 includes an initial condition setting unit 1 that sets initial conditions such as semiconductor device structure to be simulated or biasing conditions, a mesh dividing unit 2 that divides the semiconductor device into three dimensional mesh shapes, a reference plane setting unit 3 that sets a reference plane in the semiconductor device structure divided into meshes, a space distribution setting unit 4 that calculates the impurity surface density of the reference plane by folding the impurity concentration in the semiconductor device structure into the reference plane, a simulation unit 5 that performs two dimensional device simulation using the impurity surface density of the reference plane, and a statistic analyzing unit 6 that calculates the mean value, the standard deviation, and the degree of distortion etc. of the device characteristics. Each unit of FIG. 1 is implemented as software which can be run on, for example, a personal computer or a workstation.

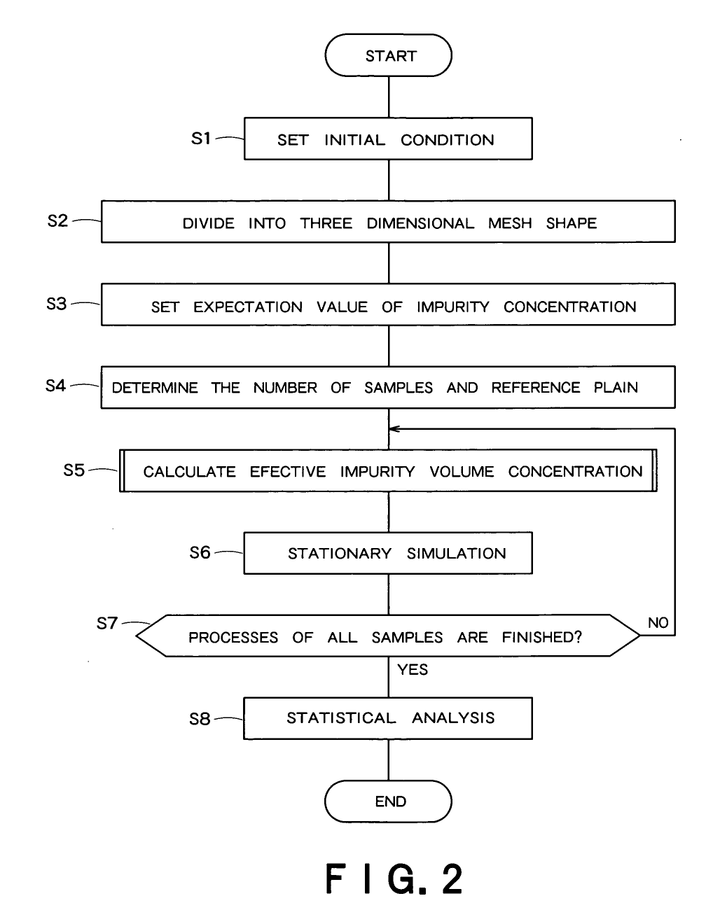

FIG. 2 is a flow chart illustrating the processing operations of the device simulation apparatus of FIG. 1. Now, according to FIG. 2, processing operations of the device simulation apparatus of FIG. 1 will be described.

First, the initial condition setting unit 1 sets initial conditions such as semiconductor device structure or voltage biasing conditions that user wants to analyze (step S1). For example, when simulation of the current-voltage condition of MOSFET is performed, conditions such as gate length, gate width, drain bias and gate bias are set.

Next, the mesh dividing unit 2 divides the semiconductor device structure into three dimensional mesh shapes (step S2), and sets an expectation value of impurity concentration corresponding to a designed target value of MOSFET into a control volume representing the basic unit of the meshes (step S3). The expectation value of the number of the impurity ions contained in the control volume becomes a value that is a product of the impurity concentration and the volume of the control volume. Here, the control volume denotes a special range surrounded by midpoints of neighboring lattice points of the meshes as a boundary. Alternatively, the control volume may be set using mesh lattice points as apexes.

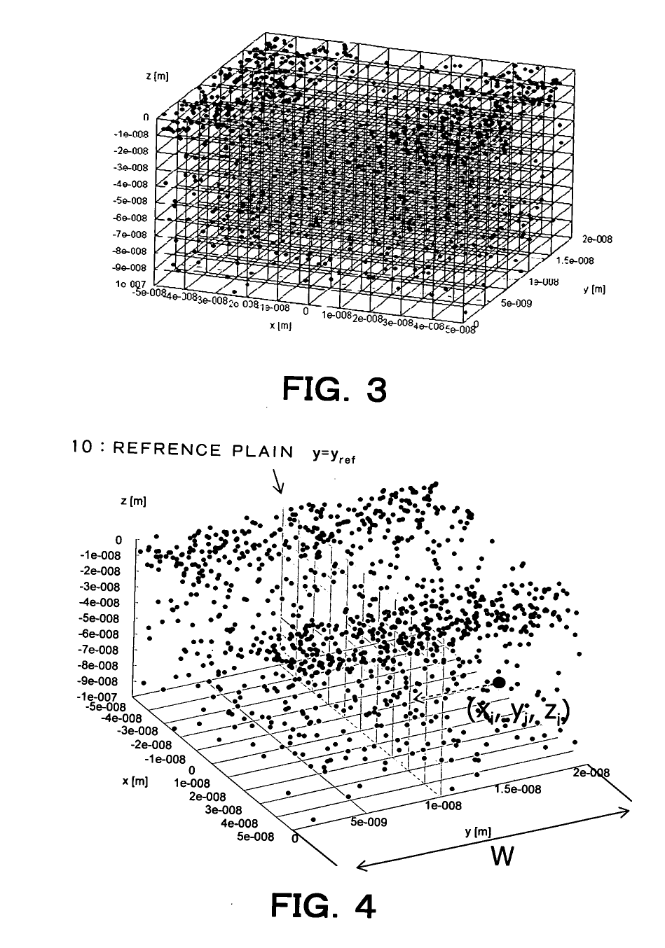

FIG. 3 is a view illustrating an example in which impurity concentration is allocated to each control volume. Solid lines in FIG. 3 represent meshes, and black circles represent impurity atoms.

Next, the reference plane setting unit 3 determines the sample number and reference plane for performing statistical analysis (step S4). As mentioned above, it is required to calculate at least 200 of simulation samples for the simulation results to be within ±10% error from the population variance at 95% degree of reliability, however, the sample number may be increased or decreased depending on the required accuracy of statistical analysis.

The reference plane determined in the above mentioned step S4 is intended to be common to each sample, here the reference plane is y=yref. Additionally, the reference plane is provided along the three dimensional meshes generated in step S2, and divided into meshes.

FIG. 4 is a view illustrating one example of the reference plane 10. If the length and the coordinate of the width direction (y direction) that is intended to be eliminated, are defined as W, and −W/2<y<W/2, yref is required to be provided within the range; −W/2<yref<W/2.

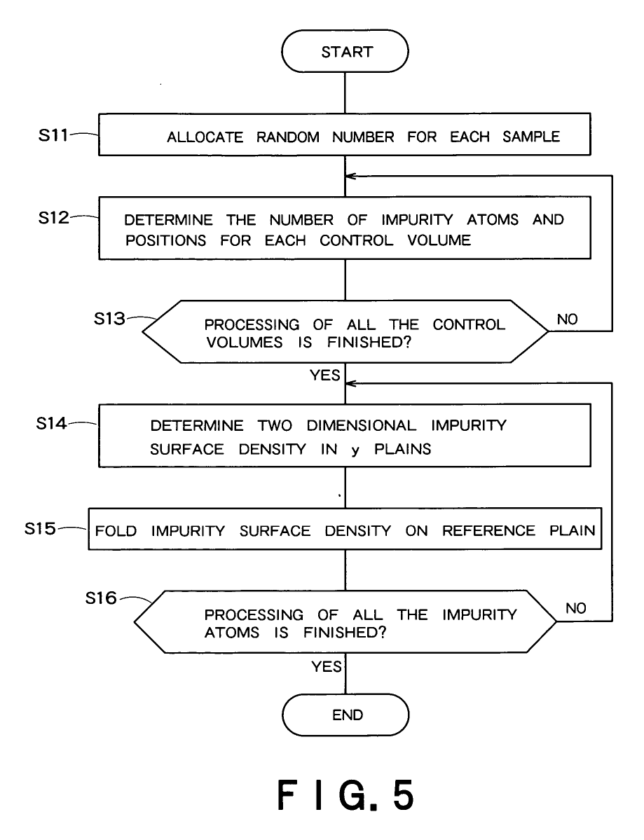

Next, the space distribution setting unit 4 calculates the effective impurity volume concentration for each sample (step S5). The processing in step S5 is, more particularly, performed according to the procedures in FIG. 5.

First, specific random number species is allocated for each sample (S11). The random number species is used for setting the impurity positions in the control volume for each sample.

Next, information of the three dimensional number and positions of impurity atoms contained (impurity profile) in the sample is determined (step S12). The number and the positions of impurity atoms are determined for each control volume calculated in step S2. The concentration of the impurities contained in the control volume is determined by random numbers which follow to Poisson distribution. The mean value of the random numbers is equal to the expectation value of the impurity concentration defined in step S2. The positions of impurities in the control volume are determined by uniform random numbers. The initial random number species for generating these random numbers is determined in step S11, and each sample to be simulated is distinguished by changing random number species for each sample.

In step S13, whether the processing in step S12 is performed for all control volumes or not, is judged, and when the processing for all control volumes is completed, the impurity profile in the semiconductor device would be determined. Below, the impurity atoms to which the processing in step S12 is performed will be identified by adding suffix i.

After the processing in step S12 is performed for all control volumes, two dimensional donor impurity surface density in the y planes to which each impurity ion belongs, is determined (step S14). Here, suppose the situation that the two dimensional donor impurity surface density Nd_{i,2D}(x, z, xi, yi, zi) due to impurity i at the coordinate (x, yi, z) at which the impurity i is positioned, is determined. Most simply, if the impurities are considered as point charges, two dimensional donor impurity surface density Nd_{i,2D}(x z, xi, yi, zi) is expressed by equation (6) using Dirac delta function.
Nd_{i,2D}(x,z,xᵢ,yᵢ,zᵢ)=δ(x−xᵢ)δ(z−zᵢ)=Nd_{i,2D}(x−xᵢ,yᵢ,z−zᵢ) (6)

For simplification, if the impurity exists at the position (xi=0, yi, zi=0), equation (6) is expressed by equation (7).
Nd_{i,2D}(x−0, yᵢ, z−0)=Nd_{i,2D}(x, yᵢ, z)=δ(x)δ(z) (7)

From the equation (7), the two dimensional donor surface density due to the impurity i, at the coordinate (x, yi, z) in the plane of y=yi in which the impurity i is positioned, can be calculated.

If the impurities are considered as point charges of delta [symbol] function, when the mesh is divided into very finely, the capture of majority carriers due to impurity charges may occur, resulting in that the simulation results strongly depend on the fineness of the mesh. This is undesirable in designing the semiconductor device.

Therefore, in this embodiment, as shown in equation (8), the two dimensional donor surface density Nd_{i,2D}(x, yi, z) that is expressed by delta function, is provided with a cutoff wave number kc to be expressed in inverse Fourier transformation.

$$\begin{matrix}{Nd}_{ i , 2 D} ( x , {y}_{i} , z ) = {Nd}_{i , 2 D} ( R , {y}_{i} ) \\ = \frac{1}{2 π {R}^{2}} \int ⅆ {k}_{\vert \vert} {ⅇ}^{ⅈ {k}_{\vert \vert} \cdot R} \\ = \frac{1}{2 π {R}^{2}} {\int }_{0}^{kcR} ⅆ u u {J}_{0} ( u )\end{matrix} \qquad ( 8 )$$

Where, vector R (boldface R) means two dimensional position vector (x, z). R (lightface R) is a scalar value of the vector R. The scalar R is expressed by equation (9).
R=\sqrt{x²+z²} (9)

The vector kₗₗ in equation (8) means a two dimensional wave number vector (kx, kz). Jo(u) is Bessel function of the first kind zero order, and kc is a parameter having inverse dimension of distance. For example, the kc is substantially equal to the inverse of the mean distance between impurities, and can hold the relation, kc=2Ndₘ^{-1/3}, between itself and the expectation value Ndₘ of macroscopic donor concentrations in the control volume to which the impurities belong, which is defined in step S2. Alternatively, kc may be considered as a fitting parameter for reproducing the measured value of an experiment.

The two dimensional donor surface density Nd_{i,2D}(x, yi, z) maps Coulomb point charge of impurity i that exists at position (xi=0, yi, zi=0) on a two dimensional grid (x, z) in y=yi plane as two dimensional donor surface density, and is expressed using a triangle function such as sin or cos. Also, the two dimensional donor surface density Nd_{i,2D}(x, yi, z) has as an argument a non-dimensional parameter kcR obtained by multiplying a cut-off wave number parameter kc used for Fourier transformation of the position coordinates of donor impurities expressed by delta function in nature, by the parameter R in equation (9) expressing a distance between the impurity and the grid (x, yi, z). Thus, the two dimensional donor surface density Nd_{i,2D}(x, yi, z) in equation (8) may also be expressed by the following equation (10).

$$\begin{matrix}{Nd}_{ i , 2 D} ( x , {y}_{i} , z ) = {Nd}_{i , 2 D} ( R , {y}_{i} ) \\ = {Nd}_{i , 3 D} ( R ) W \\ = \frac{W}{2 {π}^{2}} \frac{sin {k}_{c} R - {k}_{c} R cos {k}_{c} R}{{R}^{3}}\end{matrix} \qquad ( 10 )$$

Here, W is the width of the semiconductor device.

In the above description, for simplification, the two dimensional donor surface density Nd_{i,2D} has been derived by assuming that impurity exists at a point (xi=0, yi, zi=0). However, if impurity exists at a point (xi, yi, zi), a general equation of the two dimensional donor surface density Nd_{i,2D} may be expressed by substituting |R-Ri| shown by the following equation (11) into R of equations (8) or (10).
|R−Rᵢ|=\sqrt{(x−xᵢ)²+(z−zᵢ)²} (11)

Using the two dimensional donor surface density Nd_{i,2D} calculated in the above procedure, the impurity surface density due to impurity i is allocated to grid (x, yi, z) in the y=yi plane, based on the equations (8) or (10). The surface density at the grid (x, yi, z) due to impurity i in the y=yi plane is expressed by equation (12) by substituting |R−Ri| to the argument R, when the two dimensional donor density Nd_{i,2D} is expressed by equation (10).

$${Nd}_{ i , 2 D} ( \sqrt{{( x - {x}_{i} )}^{2} + {( z - {z}_{i} )}^{2}} , {y}_{i} ) = \frac{W}{2 {π}^{2}} \frac{\begin{matrix}sin {k}_{c} \sqrt{{( x - {x}_{i} )}^{2} + {( z - {z}_{i} )}^{2}} - \\ {k}_{ c} \sqrt{{( x - {x}_{i} )}^{2} + {( z - {z}_{i} )}^{2}} \\ cos {k}_{c} \sqrt{{( x - {x}_{i} )}^{2} + {( z - {z}_{i} )}^{2}}\end{matrix}}{{\sqrt{{( x - {x}_{i} )}^{2} + {( z - {z}_{i} )}^{2}}}^{3}} \qquad ( 12 )$$

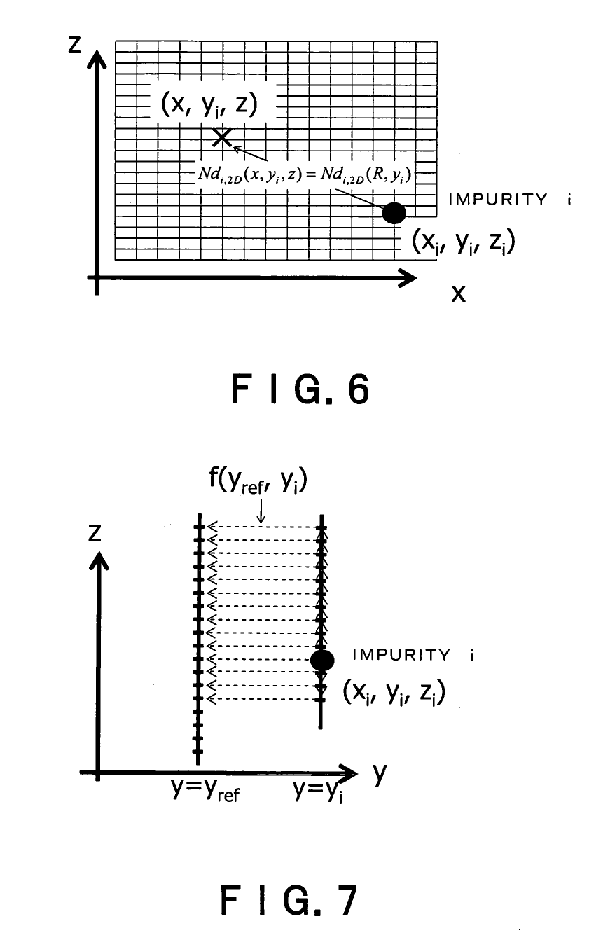

By the above procedure, the surface density Nd_{i,2D} (x, yi, z) due to impurity i at the grid (x, yi, z) on the y=yi plane to which the impurity i belongs, can be calculated. FIG. 6 is a schematic view of the processing in step S14 described above, illustrating how impurity atom i positioning at arbitrary position on the y=yi plane, is allocated to a predetermined grid on the same plane.

Next, using a weighted function, the surface density derived in step S14, is re-converted into the impurity surface density on the reference plane, and by dividing it with length W in the device width direction of which dimension is intended to be eliminated, the impurity surface density is converted into volume concentration (step S15). Thus, as shown in FIG. 7, using the weighted function, the surface density Nd_{i,2D} (xi, yi, zi) of impurity i is weighted to fold it in a mesh (x, yref, z) on the reference plane, and divided with length W in the device width direction to be converted into volume concentration. The arrow in the z-direction of the y=yi in FIG. 7 denotes the allocation to the grid in step S14, the arrow from y=yi to yref denotes the folding in step S15.

In such a manner, if the impurity concentration that the impurity i existing at the position ri=(xi, yi, zi) is allocated to the grid (x, yref, z) is defined as Nd_{i3D,eff} (x, yref, z), the Nd_{i3D,eff} (x, yref, z) is expressed by equation (13).

$${Nd}_{ i , 3 D , eff} ( x , {y}_{ ref , } z ) = \frac{ {Nd}_{i , 2 D} ( \sqrt{\begin{matrix}{( x - {x}_{i} )}^{2} + \\ {( z - {z}_{ i} )}^{2}\end{matrix}} , {y}_{i} )}{W} f ( {y}_{i} , {y}_{ref} ) \qquad ( 13 )$$

Here, f(yi, yref) is a weighted function. N means the number of donors contained in the device. The reason for dividing with the length W in the direction of which dimension is eliminated, corresponds to the fact that the effective impurity surface density allocated to the two dimensional mesh on the reference plane y=yref is converted into volume concentration.

The functional type of the weighted function f(yi, yref) may be any function that decreases as the distance between the position coordinate yi in y-direction of impurity i and the reference plane y=yref increases. However, if considering the conservation condition of existence probability of impurity, it is required to meet the following equation (14).

$${\int }_{- W / 2}^{W / 2} ⅆ {y}_{i} f ( {y}_{i} , {y}_{ref} ) = 1 \qquad ( 14 )$$

There are various functional types that satisfy equation (14), even in only the case of reference plane yref=0, functional types that exponentially decrease as equation (15) or functional types that decrease linearly as shown in equation (16) may be considered.

$$\begin{matrix}f ( {y}_{i} , 0 ) = \frac{1}{W ( 1 - exp ( - 1 ) )} exp ( - \frac{2 \vert {y}_{i} \vert}{W} ) & ( 15 ) \\ f ( {y}_{i} , 0 ) = \frac{3}{2} - \frac{\vert {y}_{i} \vert}{W} & ( 16 )\end{matrix}$$

Next, whether the processes in steps S14, S15 are performed by times of the number of impurity (donor) atoms or not, is judged (step S16), if there are unprocessed impurity (donor) atoms, the processes in steps S14, S15 are repeated, and when the processes for all impurity (donor) atoms are completed, calculation in the following equation (17) is performed to allocate the impurity Nd_{3D,eff}(x, yref, z) on the discrete reference plane (x, yref, z) which is divided by two dimensional lattice.

$$\begin{matrix}{Nd}_{ i , 3 D , eff} ( x , {y}_{ ref , } z ) = {\sum }_{i = 1}^{N} \frac{{Nd}_{i , 2 D} ( \sqrt{{( x - {x}_{i} )}^{2} + {( z - {z}_{i} )}^{2}} , {y}_{i} )}{W} \\ f ( {y}_{i} , {y}_{ref} )\end{matrix} \qquad ( 17 )$$

Here, N denotes the number of donors contained in the device.

The above processes indicate the method to allocate donor type impurities. The same process is performed even in acceptor type impurities. That is, the step S5 in FIG. 2 (the process in FIG. 5) is performed to obtain Nd_{3D,eff}(x, yref, z).

When the process in step S5 is completed using the above procedure, the simulation unit 5 performs stationary simulation (step S6) using Nd_{3D,eff}(x, yref, z), and Na_{3D,eff}(x, yref, z) shown in equation (17). That is, in the step S6, a transportation problem of electrons or holes running in a three dimensional space in nature, is converted into a transportation problem of electrons or holes running in an effective two dimensional space.

$$\begin{matrix}\begin{matrix}\begin{matrix}{∇}_{2 D} ɛ \cdot {∇}_{2 D} \\ {ϕ}_{ eff} ( x , {y}_{ ref} , z )\end{matrix} = - \frac{q}{ ɛ} ( p - n + {Nd}_{ 3 D , eff} ( x , {y}_{ ref} , z ) - \\ {Na}_{3 D , eff} ( x , {y}_{ref} , z ) )\end{matrix} & ( 18 ) \\ {∇}_{2 D} \cdot {nv}_{e} = GR & ( 19 ) \\ {∇}_{2 D} \cdot {pv}_{h} = GR & ( 20 )\end{matrix}$$

This enables the calculation of device properties using a two dimensional device simulator. Poisson equations of governing equations for device properties at that time, are expressed by equations (18) to (20). Equations of continuity of current, are also expressed by equations (21) and (22).

$$\begin{matrix}{nv}_{e} = {μ}_{e} ( - n {∇}_{2 D} {ϕ}_{eff} + \frac{{k}_{B}}{q} {∇}_{2 D} ( {nT}_{e} ) ) & ( 21 ) \\ {pv}_{h} = {μ}_{h} ( p {∇}_{2 D} {ϕ}_{eff} + \frac{{k}_{B}}{q} {∇}_{2 D} ( {pT}_{h} ) ) & ( 22 )\end{matrix}$$

These equations (18) to (22) are those in which differential operators in the above equations (1) to (5) are substituted by two dimensional differential operators, except the direction of which dimension is eliminated (in this embodiment, y-direction). By self-consistently solving equations (18) to (22), semiconductor device properties such as current-voltage characteristics are calculated.

The processes in steps S5, S6 of FIG. 2, are repeated at times depending on the number of the samples defined in step S4 (step S7). After the processes in steps S5, S6 are repeated at times of the number of the samples, the statistic analyzing unit 6 performs statistical analysis of the variation of the device properties (step S8). Therefore, it is possible to quantitatively detect the statistical quantity of the variation of the device properties due to impurity fluctuation under the expectation values of the device structure and the biasing conditions inputted in steps S1, S2.

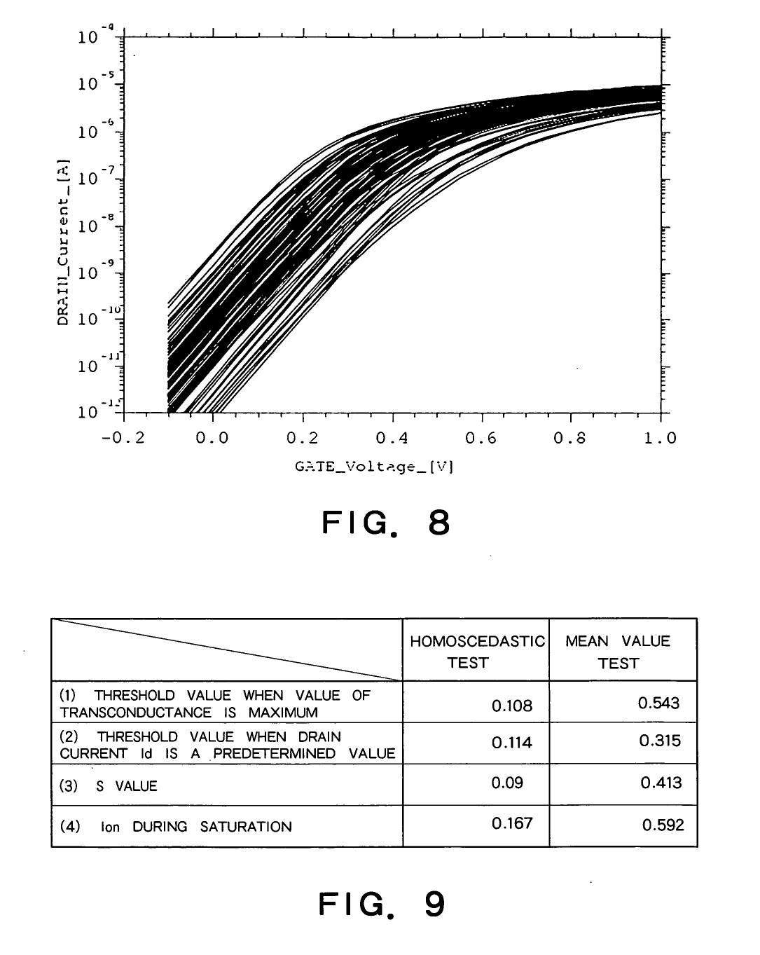

FIG. 8 is a view of current-voltage characteristics resulting from the calculation performed by concerning impurity fluctuation for two hundreds of n-type MOSFETs, which is the same number as that of the device structures from which Id-Vg characteristics is derived. FIG. 8 shows an example of situation that the position coordinate of the reference plane yref is yref=0, and the equation (16) is used as the weighted function of effective impurity concentrations Nd_{3D,eff}(x, yref, z), Na_{3D,eff} (x, yref, z) to be substituted into the left-hand side of equation (18). During calculation of FIG. 8, Sun4U Ultra-SPARCIII 1280 MHz (Memory capacity; 8 GB) workstation is used. The calculation time of 120 hours necessary for the analysis using a three dimensional simulator has been shortened to less than 3 hours in the present embodiment, thereby largely shortening the calculation time.

FIG. 9 is a view illustrating the results of significance tests between the result of the three dimensional device simulation using a known model and the result of the simulation by the manner of the present embodiment. More particularly, P values of homoscedastic test and mean value test are shown for each value of (1) threshold value when the value of transconductance (Gm value) is maximum, (2) threshold value when the drain current Id is a predetermined value, (3) S value, and (4) ON current Ion during saturation. Here, P value denotes a limit value when assumed that there is no statistically significant difference between the two simulation methods, or a probability that the statistical result deviated from the limit value is obtained. Generally, it is indicated that there is no significant difference between both of them if P value is larger than 0.05.

During performing the significance test in FIG. 9, it is assumed that the populations follow normal distribution. The tests are performed using MINITAB (trade mark) of MINITAB company at 5% of significance level of the test. In the procedure of the test, after confirming firstly that there is no significance difference between standard deviations of populations using Homogeneity of variance test, the test of mean value is performed using two sample t-test.

As seen in FIG. 9, in any of situations (1) to (4), the P values are above 0.05. It is understood that the simulation method of this embodiment has no significant difference, compared with the simulation method using a known three dimensional simulator. Therefore, it could be confirmed that this embodiment statistically reproduces the results of mean values and standard deviations of the ON current Ion and the OFF current Ioff derived from the three dimensional simulator at 5% of significance level.

Thus, in this embodiment, since the three dimensional impurity distribution of the semiconductor device structure is folded into the two dimensional reference plane to perform the two dimensional simulation, it is possible to perform the simulation, in a greatly higher speed than that of the three dimensional simulation, at accuracy without statistical significance difference. Therefore, it is possible to perform the simulation at much higher speed than the three dimensional simulation while holding accuracy which does not have statistically significant difference, compared with the three dimensional simulation. Therefore, it is possible to predict the problem of variation of the device characteristics due to impurity fluctuation which occurs in the micro structure transistor at high accuracy and a short time.

The device simulation apparatus described in the above embodiment may be configured with hardware or software. If it is configured with software, programs that achieve at least a part of the functions of the device simulation apparatus may be stored in a storage medium such as a floppy disk or a CD-ROM to make a computer read it out for execution. The storage medium is not limited to a portable medium such as a magnetic disk or an optical disk, and it may be a fixed medium such as a hard disk device or a memory.

The programs that achieve at least a part of the functions of the device simulation apparatus may be also distributed via a communication line (including wireless circuit) such as internet. Furthermore, the programs may be distributed via wire circuit or wireless circuit such as internet, or by storing in a storage medium, in a coded, modulated, or compressed state.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A device simulation apparatus, comprising:
a mesh dividing unit configured to divide a semiconductor device structure for a simulation into three dimensional mesh shape to form a plurality of control volumes, each corresponding to a basic unit divided into mesh shape;
an impurity concentration setting unit configured to set the number or positions of impurity atoms for each of the control volumes;
a reference plane setting unit configured to set a reference plane as a standard for calculating a impurity surface density in the semiconductor device structure divided in mesh shape;
an impurity profile determination unit configured to determine a impurity profile of the semiconductor device structure based on the number or positions of the impurity atoms set by the impurity concentration setting unit;
an impurity surface density determination unit configured to determine the impurity surface density on a surface in a predetermined direction, the surface passing through the position of each impurity atom;
a folding unit which folds the impurity surface density corresponding to each impurity atom determined by the impurity surface density determination unit, on the reference plane; and
an electric property estimating unit configured to estimate electric properties of the semiconductor device structure by using the impurity surface density on the reference plane folded by the folding unit.

2. The apparatus according to claim 1,
wherein the impurity surface density determination unit determines the impurity surface density on a plane in parallel to the reference plane.

3. The apparatus according to claim 1, further comprising a weighting unit configured to add a weight to the impurity surface density determined by the impurity surface density determination unit in accordance with a distance from the reference plane,
the folding unit allocating the impurity surface density to which the weight is added, on the reference plane.

4. The apparatus according to claim 3,
wherein the weighting unit generates the weight by multiplying a weight function in which the amount of weight decreases as a distance from the reference plane is far, by the impurity surface density.

5. The apparatus according to claim 4,
wherein a value of the weight function becomes “1” when the weight function is integrated along a direction that the folding unit folds the impurity surface density.

6. The apparatus according to claim 1,
wherein the reference plane setting unit sets the reference plane in a center of the semiconductor device structure.

7. The apparatus according to claim 1,
wherein the impurity atoms set by the impurity concentration setting unit are donors and acceptors included in the semiconductor device structure; and
the reference plane setting unit, the impurity profile determination unit, the impurity surface density determination unit, the folding unit and the electric property estimating unit perform the respective processes separately for each of the donors and the acceptors.

8. The apparatus according to claim 1, further comprising:
a simulation sample setting unit configured to set the number of samples expressing the number of the semiconductor device structure for simulation; and
a statistic analyzing unit configured to statistically analyze the properties of the semiconductor device structure based on the results processed by the impurity profile determination unit, the impurity surface density determination unit, the folding unit and the electric property estimating unit for each sample.

9. The apparatus according to claim 8, further comprising:
a random number generator configured to generate a random number for each sample,
the impurity profile determination unit determining the impurity profile of the semiconductor device structure based on the random number generated by the random number generator.

10. A device simulation method, comprising:
dividing a semiconductor device structure for simulation into three dimensional mesh shape to form a plurality of control volumes, each corresponding to a basic unit divided into mesh shape;
setting the number or positions of impurity atoms for each of the control volumes;
setting a reference plane as a standard for calculating a impurity surface density in the semiconductor device structure divided into mesh shape;
determining a impurity profile of the semiconductor device structure based on the set number or positions of the impurity atoms;
determining the impurity surface density on a surface in a predetermined direction based on the impurity profile, the surface passing through the position of each impurity atom;
folding the impurity surface density corresponding to each of the determined impurity atoms, on the reference plane; and
estimating electric properties of the semiconductor device structure by using the impurity surface density on the folded reference plane.

11. The method according claim 10,
wherein the impurity surface density on a surface in parallel to the reference plane is determined based on the impurity profile.

12. The method according claim 10,
wherein a weight is added to the determined impurity surface density in accordance with a distance from the reference plane; and
the impurity surface density to which the weight is added is allocated on the reference plane.

13. The method according claim 12,
wherein the weight is obtained by multiplying a weight function in which the amount of weight decreases as a distance from the reference plane is far, by the impurity surface density.

14. The method according claim 13,
wherein a value of the weight function becomes “1” when the weight function is integrated along the folded direction.

15. The method according claim 10,
wherein the reference plane is set in a center of the semiconductor device structure.

16. The method according claim 10,
wherein the impurity atoms are donors and acceptors included in the semiconductor device structure; and
the setting of the reference plane, the determination of the impurity profile, the determination of the impurity surface density, the folding and estimation of the electric properties are performed separately for each of the donors and the acceptors.

17. The method according claim 10,
wherein the number of samples expressing the number of the semiconductor device structure for simulation is set; and
properties of the semiconductor device structure is statistically analyzed based on setting of the reference plane, determination of the impurity profile, determination of the impurity surface density, the folding and estimation of the electric properties for each sample.

18. The method according claim 17,
wherein a random number is generated for each sample; and
the impurity profile of the semiconductor device structure is determined based on the random number.

19. A device simulation program for controlling a computer, comprising:
dividing a semiconductor device structure for simulation into three dimensional mesh shape to form a plurality of control volumes, each corresponding to a basic unit divided into mesh shape;
setting the number or positions of impurity atoms for each of the control volumes;
setting a reference plane as a standard for calculating a impurity surface density in the semiconductor device structure divided into mesh shape;
determining a impurity profile of the semiconductor device structure based on the set number or positions of the impurity atoms;
determining the impurity surface density on a surface in a predetermined direction based on the impurity profile, the surface passing through the position of each impurity atom;
folding the impurity surface density corresponding to each of the determined impurity atoms, on the reference plane; and
estimating electric properties of the semiconductor device structure by using the impurity surface density on the folded reference plane.

20. The program according to claim 19,
wherein a weight is added to the determined impurity surface density in accordance with a distance from the reference plane; and
the impurity surface density to which the weight is added is allocated on the reference plane to perform a folding process.
